(19) United States
(12) Patent Application Publication
(10) Pub. No.: US 2005/0004797 A1
(43) Pub. Date: Jan. 6, 2005

(54) Method for identifying specific sounds

(76) Inventor: Robert Azencott, Paris (FR)

Correspondence Address: MCDERMOTT WILL & EMERY LLP, 600 13TH STREET, N.W., WASHINGTON, DC, 20005-3096, US

(21) Appl. No.: 10/835,280

(22) Filed: Apr. 30, 2004

(30) Foreign Application Priority Data
May 2, 2003 (FR) 03/05414

(51) Int. Cl. G10L 21/00

(52) U.S. Cl. 704/226

(57) ABSTRACT

A method of automated identification of specific sounds in a noise environment, comprising the steps of: a) continuously recording the noise environment, b) forming a spectral image of the sound recorded in a time/frequency coordinate system, c) analyzing time-sliding windows of the spectral image, d) selecting a family of filters, each of which defines a frequency band and an energy band, e) applying each of the filters to each of the sliding windows, and identifying connected components or formants, which are window fragments formed of neighboring points of close frequencies and powers, f) calculating descriptors of each formant, and g) calculating a distance between two formants by comparing the descriptors of the first formant with those of the second formant.

### BACKGROUND OF THE INVENTION

1. Field of the Invention

The present invention relates to a method for identifying specific sounds.

It specifically applies to the forming of an embarked automated audio-surveillance system intended for real-time detection, by audio telediagnosis, of situations exhibiting security risks, in the context of the simultaneous surveillance of a set of fixed or mobile units.

2. Discussion of the Related Art

This set of units simultaneously monitored by the audio-surveillance system may include up to several thousands of units, and for example be of one of the three following types:
a fleet of vehicles such as buses, trucks, automobiles, subway coaches, railroad cars, tramways, etc.
a civil plane fleet, for example for the security surveillance in flight of the passenger cabins, or of the piloting cockpits,
an assembly of private or public premises such as car parks, buildings, warehouses, houses, railway or subway platforms, subway corridors, etc.

The situations exhibiting security risks that the telediagnosis system aims at detecting comprise situations of intrusions, aggressions, crises, violence, disorders, and most particularly those endangering the physical security of the conductors or of the passengers of the mobile units under surveillance, or again of the users of the public places or private premises under surveillance. They also comprise situations likely to cause damage to the monitored vehicles or premises (such as glass breaking, felonious entries, graffiti and tags, willful damage, thefts, etc.).

In the present state of the art, such surveillance operations are generally performed by video cameras. This requires for an operator to permanently watch screens. Possibly, in video systems, it is possible to detect in an environment in which there normally is no motion that a motion occurs, and then only is the operator's attention attracted. However, this is incompatible with the surveillance of units such as buses, railroad cars, subway coaches, other means of transportation, or permanently inhabited premises, since there then always exists a motion and the detection of a risk situation requires specific vigilance. An operator can thus only watch a limited number of screens.

### SUMMARY OF THE INVENTION

The present invention aims at automatically detecting risk situations and at providing real-time alarms based on noises or abnormal noise environments, which would be identified upon listening by an attentive human operator.

Another object of the present invention is to provide a method of real-time automated detection executable on a conventional microcomputer.

Another object of the present invention is to provide such a method and such a system in which a surveillance database can be established without requiring intervention of an acoustical analysis specialist.

Generally, to achieve these objects, the present invention provides forming an audio database corresponding to risk situations. For this purpose, in a preparatory phase, recordings taken in the environments which are desired to be studied (buses, subways, thoroughfares) are listened to by operators. Each time they hear a noise corresponding to a risk situation (glass breaking, felonious entries, damage, gun shots, threatening words), the operator marks the location where he has heard the corresponding sound (possibly voluntarily caused) and indicates which type of situation he has heard. This operator needs not be a specialist of acoustics. He must only be an attentive listener. Then, automatically, the present invention provides analyzing the areas of the sound track where the risk situation has been detected, performing transformations on these areas to provide spectral images thereof, identifying in the spectral images sound formants, that is, contiguous areas located in determined frequency and power ranges, characterizing the formants, and comparing the set of detected formants of the various locations where the operator has detected a specific situation. Then, the program automatically provides by comparison and selection the sets of specific formants of the areas where the noise corresponding to a determined risk has been heard. The corresponding formant sets are called signatures.

Then, once the system is in operation, the noise environments are continuously detected in the various locations which are desired to be monitored and, in real time, a time-to-frequency conversion is performed and the formants are extracted. Each time a formant appears, it is compared with the formants of the database and it is detected whether the predetermined signatures appear. In the case where a signature appears, an alarm is provided, which may be confirmed in various ways before starting an intervention. Such a system enables simultaneous surveillance of a large number of units, that may range up to several thousands.

More specifically, the present invention provides a method of automated identification of specific sounds in a noise environment, comprising the steps of:
a) continuously recording the noise environment,
b) forming a spectral image of the recorded sound in a time/frequency coordinate system,
c) analyzing time-sliding windows of the spectral image,
d) selecting a family of filters, each of which defines a frequency band and an energy band,
e) applying each of the filters to each of the sliding windows, and identifying connected components or formants, which are window fragments formed of neighboring points of close frequencies and powers,
f) calculating descriptors of each formant, and
g) calculating a distance between two formants by comparing the descriptors of the first formant with those of the second formant.

The present invention also provides a method of automated identification of the signature of a specific noise type in a sound recording, comprising the steps of:
listening to the recording and marking the times at which a specific noise occurs,
applying the above-mentioned method of automated identification of specific sounds and, at step g), comparing the formants present in the windows substantially corresponding to the marked times, and
note down the formants common to all the windows corresponding to the marked times, these common formants altogether forming said signature, two formants being considered as identical if their distance is smaller than a set threshold.

The present invention also provides a method of automated identification of specific sounds in a noise environment, consisting of applying the above-mentioned method of automated identification of specific sounds and, at step g), of comparing the descriptors of the formants of each sliding window with formants belonging to a predetermined signature.

According to an embodiment of the present invention, the descriptors comprise a descriptor of geometric shape GeomC which is formed of the set of points of the formant to which a time translation has been applied to bring all the formants back to a same origin; and at least one of the following descriptors:
D2: relative surface area SurfC, that is, the ratio of the number of points of the formant to the number of points (L×k) of the analysis window;
D3: duration DuréeC, equal to v−u, where u and v respectively are the minimum and the maximum of abscissas t of the formant points;
D4: mean spectral energy MeanEnerC;
D5: the mean square deviation of spectral energies DispEnerC;
D6: frequency band BFreqC, which is the frequency interval, that is, the difference between the minimum and the maximum of the formant ordinates; and
D7: energy band BEnerC, which is the interval between the minimum and the maximum of the energies (Sₜⱼ) of the formant points.

According to an embodiment of the present invention, the distance between geometric shapes of two formants C and P is evaluated by calculated a raw numerical interval H(C,P):
H(C,P)=a/n(C)+b/n(P)
where n(C) and n(P) are the respective numbers of points of C and P, a is the number of points of C that do not belong to P, and b is the number of points of P that do not belong to C.

According to an embodiment of the present invention, the distance between the geometric shapes of two formants is evaluated by comparing the first formant with various instances of the second formant having undergone linear transformations (translation and expansion) of reduced amplitudes and by retaining the minimum distance.

The present invention also provides a system of automated identification of specific sounds in a sound environment, comprising sound recording means and a microcomputer incorporating a software capable of implementing one of the above-mentioned methods.

The present invention also provides a system of automated identification of specific sounds such as mentioned hereabove, in each of a plurality of units under surveillance and means of alarm transmission to at least one central station.

The foregoing and other objects, features, and advantages of the present invention will be discussed in detail in the following non-limiting description of specific embodiments in connection with the accompanying drawings.

### BRIEF DESCRIPTION OF THE DRAWINGS

FIG. 1 shows a spectral image;

FIG. 2 shows formants identified in an analysis window of a spectral image;

FIGS. 3A, 3B, and 3C show various geometric shapes of formants to be compared.

### DETAILED DESCRIPTION

In the present description, a sound data processing mode used according to the present invention (part 1) and a mode of sound formant description and of determination of the distance between sound formants according to the present invention (part 2) will first be discussed. Then, the use of the sound formants defined according to the present invention for the generation of sound signatures of characteristic noises upon implementation of an automated training (part 3) and the use of this signature base for the real-time detection of characteristic noise (part 4) will be described. Finally, the hardware used to implement the present invention and various possible alternatives (part 5) will summarily be described.

1. Sound Data Processing

1.1. Obtaining of a Spectral Image

A sound recording is digitized in real time to generate down the stream a sequence of digitized acoustic pressures, sampled at high frequency, for example, at 50 kHz.

A fast Fourier transform (FFT) is then applied to this digitized pressure sequence. This operation generates down the stream, at a slower rate, for example, on the order of from 5 to 10 times per second, an instantaneous spectrogram sequence Spec(t), where t designates the calculation time of Spec(t).

Each spectrogram Spec(t) is a vector of dimension “k” set by the user. k most often is a power of 2, for example 512. This vector is the result of the spectral analysis of the sound signal over a determined time interval set by the user, for example, on the order of from ⅕ to 1/10 of a second.

For the real-time implementation of this calculation, the user will select the general sound frequency band to be analyzed, for example, between 1 and 30.000 Hz, and the subdivision of this frequency interval into “k” consecutive frequency bands, for example, of same width, or yet of widths defined by a logarithmic scale.

Coordinate number “j” (1<j<k) of vector Spec(t), here designated as Stj, represents the spectral energy of the sound signal in frequency band number j during the time interval over which the FFT is performed.

Each component of coordinate j may be affected with a weighting coefficient (attenuation or amplification) before transmission to the next processing.

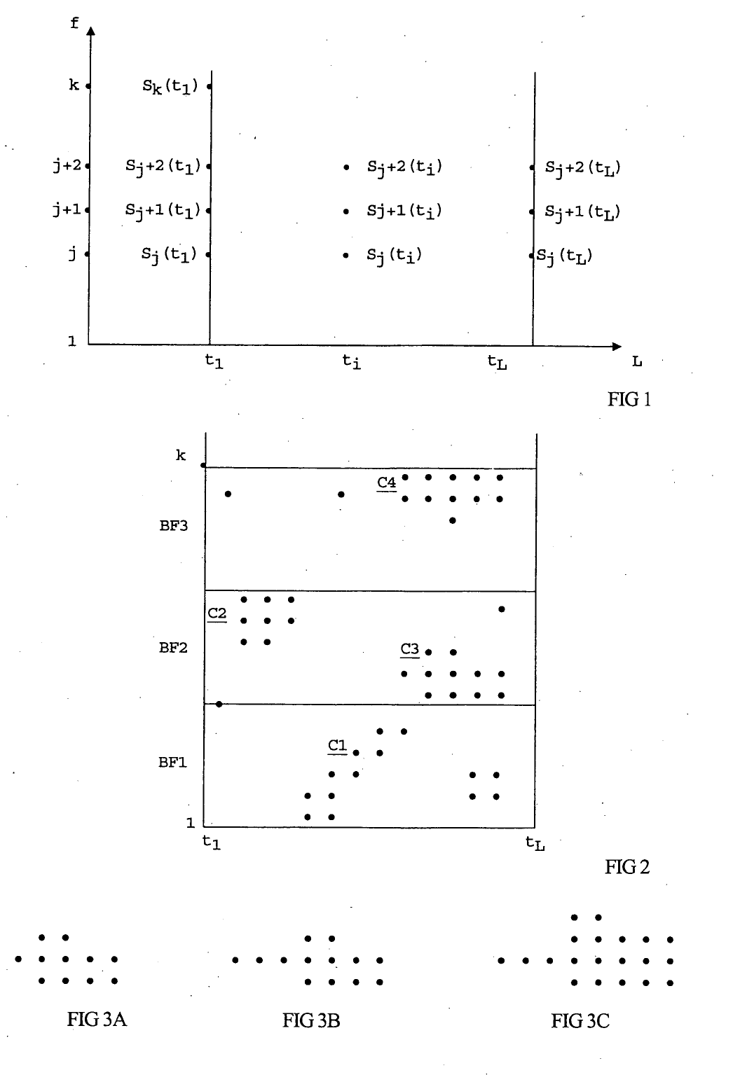

FIG. 1 enables better understanding the obtained result. The complete time sequence of the spectrograms Spec(t) may be represented as an image called the “spectral image” where the abscissas represent time and the ordinates represent the k frequency bands. In this image, the point of abscissa t and of ordinate j has a “light intensity” equal to spectral energy Stj. The various intensities may for example be displayed by different colors. It should be noted that the spectral image will in fact not be displayed in the implementation of the method according to the present invention which is performed in automated fashion with no human analysis of the spectrograms. Reference will however be made hereafter to this spectral image to simplify explanations.

1.2. On-the-Fly Formant Extraction

The present invention then provides the real-time computer analysis of the sequence of spectrograms Spec(t) to extract therefrom down the stream a finite family of “formants”. “Formant” is here used to designate a set of neighboring points of the spectral image of “close” intensities in a meaning specified hereafter. In the spectral image, two elements are said to be “neighbors” if they have a same ordinate j and consecutive abscissas, or if they have a same abscissa t and consecutive ordinates.

The present invention provides defining in the spectral image a sliding analysis window of extent L (between times t1 and tL).

Thus, at each time s, the method provides selecting in the spectral image an analysis window comprising all the spectral energies Stj, for t ranging s−L and s, and j ranging between 1 and k.

The present invention provides setting a finite list of “energy/frequency selectors”. Each of these selectors is defined by the choice of a spectral energy band BE and of a frequency band BF. At each time s, and for each of the selectors {BE,BF}, the method provides selecting in the analysis window set U of elements (t,j) such that:
spectral energy Stj belongs to band BE, and
frequency band j is comprised in band BF.

Then, by a known automated labeling program, all the connected components of set U, that is, the maximum subsets of set U which are formed of neighboring points are determined therein. Each connected component thus determined is called a sound formant present at time s.

After having repeated this procedure for each of the above selectors, the method has thus extracted all sound formants C1, . . . , Cn present at time s in the analysis window. Size n of this sound formant family is not fixed and generally depends on time s.

To simplify explanations, reference will be made to FIG. 2 which shows an analysis window horizontally divided into three frequency bands BF1, BF2, BF3. These frequency bands have been shown as being adjacent. Clearly, they may be separate or overlapping and a much higher number of frequency bands may be chosen. In each of the frequency bands, pixels located in a given energy band have been marked with black points. Thus, a formant C1 appears in frequency band BF1, two formants C2 and C3 appear in frequency band BF2, and a formant C4 appears in frequency band BF3. Further, in each of these frequency bands, a number of parasitic points or of very “small” formants appears, and the method provides systematically suppressing all the formants of a size (number of points) smaller than a threshold set by the user.

2. Sound Formant Characterizing

To characterize and compare formants, descriptors of these formants adapted to be compared with one another must be defined, as well as comparison methods, keeping in mind that these descriptors must be calculated in real time and the comparisons must also be performed in real time by using a current microcomputer.

### 2.1. Sound Formant Descriptor Calculation

The seven following descriptors may for example be selected for each sound formant C:
D1: geometric shape GeomC, formed of the set of points of the formant to which a time translation has been applied to bring all the formants back to a same time origin;
D2: relative surface area SurfC, that is, the ratio of the number of points of the formant to the number of points (L×k) of the analysis window;
D3: duration DuréeC, equal to v−u, where u and v respectively are the minimum and the maximum of abscissas t of the formant points;
D4: mean spectral energy MeanEnerC;
D5: the mean square deviation of spectral energies DispEnerC;
D6: frequency band BFreqC, which is the frequency interval, that is, the difference between the minimum and the maximum of the formant ordinates; and
D7: energy band BEnerC, which is the interval between the minimum and the maximum of the energies (Sₜⱼ) of the formant points.

The seven descriptors of sound formants C hereabove form a list of descriptors {D1, D2, . . . D7}.

The most complex D1=GeomC is a set of points in the plane.

Descriptors D2 . . . D5 associate with formant C four real numbers SurfC, DuréeC, MeanEnerC, DispEnerC.

The last two descriptors D6 and D7 associate with formant C a frequency interval BFreqC and an energy interval BEnerC.

Those skilled in the art may complete the list of above descriptors with other descriptors, or replace some of them with modified versions, provided that they can be calculated in real time. In particular, all the range of descriptors introduced in automated image analysis to generically describe the connected portions of an image, in particular, the textures, the shape contours, etc. may be transposed in the present context to provide new sound formant descriptors.

2.2. Calculation of the Distance Between Sound Formants

The present invention provides for each descriptor a specific calculation mode enabling evaluation for each couple C and P of sound formants (not necessarily present at the same time s) of a distortion or numerical distance d between formants C and P. The positive number d thus calculated is all the smaller as descriptors D(C) and D(P) are more alike.

The following paragraph explains the distance calculations provided according to an embodiment of the present invention for the seven descriptors provided hereabove.

(a) Distance Between Geometric Shapes

For two formants C and P, it is provided to calculate a raw numerical interval H(C,P) between the geometric shapes of C and P, by posing
H(C,P)=a/n(C)+b/n(P)
where n(C) and n(P) are the respective numbers of points of C and P, a is the number of points of C that do not belong to P, and b is the number of points of P that do not belong to C.

However, comparing for example formant C3, presented as brought back to an origin in FIG. 3A, with the formants shown in FIGS. 3B and 3C, the above operation will provide a relatively high raw interval H between the various formants. In fact, the formant of FIG. 3B is relatively close to the formant of FIG. 3A, except that it comprises on the left-hand side two additional points which most likely are parasitic points, and the formant of FIG. 3C is similar to that of FIG. 3A, but expanded. In fact, the three formants are relatively close. To emphasize the similarity between these formants, the present invention provides comparing the base formant to the other formants by applying to this formant linear transformations (translation and expansion) of moderate amplitudes. Raw interval H is then calculated several times, by replacing H(C,P) formant C with linear transformations of C (C′, C″, . . . ), and distance D(C,P) between the geometric shapes of C and P is determined as being the minimum of all raw intervals H(C′,P), H(C″,P), etc. Various families of moderate deformations of C may be set by the user, without changing the above principle.

(b) Distance Linked to Surface Areas

The distance between the surfaces areas of C and P may be expressed as:
DistSurf(C,P)=absolute value of [SurfC−SurfP]

(c) Distance Linked to Durations

The distance between the durations of C and P may be expressed as:
DistDurée(C,P)=V/D
where V=absolute value of [DuréeC−DuréeP], and D=DuréeC+DuréeP

(d) Distance Linked to the Mean Energy

The distance between the mean energies of C and P may be expressed as:
DistMean(C,P)=W/M
where W=absolute value of [MeanC−MeanP] and M=MeanC+MeanP

(e) Distance Linked to Energy Dispersion

The distance between the energy dispersions of C and P may be expressed as:
DistDisp(C,P)=d1/d2+d2/d1−2
where d1=DispC and d2=DispP

(f) Distance Linked to Frequency bands

The distance between the frequency bands BFreqC and BFreqP of C and P may be expressed as:
DistBFreq(C,P)=H(BFreqC,BFreqP)=u/a+v/b
with the following notations:
a and b: lengths of intervals BFreqC and BFreqP,
u: the length of the residual segment when all the points belonging to BFreqC are taken away from BFreqP,
v: the length of the residual segment when all the points belonging to BFreqP are taken away from BFreqC.

(g) Distance Linked to Energy Bands

The distance between the energy bands BEnerC and BEnerP of C and P may be expressed as:
DistBEner(C,P)=H(BEnerC, BEnerP)
where function H is defined as previously.

General Distance between Two Sound Formants

A general numerical distance Dist(C,P) can thus be defined between two sound formants C and P by summing up the seven partial distortions defined hereabove.

In an alternative, the user of the method may weight the seven different distortions defined hereabove with fixed multiplicative coefficients, before performing the summing providing Dist(C,P).

3. Automated Training Procedure

The method provides, in an off-line preparatory phase preceding the implementation of the method of detection and real-time identification of sound phenomena, starting the automated computer analysis of a massive base of digitized sound recordings.

The results of this automated training phase provide the calibration of a set of internal parameters of the real-time audio telediagnosis software, in the form of computer files.

The implementation of the automated training phase first provides a preprocessing of the recording base by a human operator, to label it in terms of sound content in a methodic listening.

Upon listening of each recording, an operator marks with a computerized label all the phases during which he has identified a typical noise likely to be a risk noise. This label indicates on the one hand the location on the tape at which the operator has detected the searched noise and on the other hand the type of noise concerned. This label is automatically associated with the spectral image of the concerned noise. The operator's task is then normally over. It should be noted that it implies no specific knowledge of the computer processing of sounds.

Based on the labeled base, prototype formants followed by sound signatures characteristic of specific noise are searched for.

3.1 Prototype Formants

To search for prototype formants, the various areas of the spectral image close to the areas in which a well-determined noise type has been detected are compared with one another and the formants “common” to these various areas are searched for. It should be noted that before performing this search, if an acoustics specialist is associated with the operator having listened to the tapes, he may specify a list of frequency band and energy band couples in which to preferentially search for the formants corresponding in the most pertinent fashion to each risk sound phenomenon. However, if the operator does not have this type of expert knowledge, the method provides selecting all the couples {BF,BE} of intervals forming a regular paving of the plane (in frequency and in energy) of the spectral image. Pavings at several scales may also be used simultaneously.

Then, for the search and the identification of the formants “common” to all the areas where it is estimated that there exists a same type of risk noise, the sound formant characterization and descriptor and distance calculation method discussed in part 2 of the present invention will be used. The essential point of the method here is to decide that two formants present in any two areas of the spectral image form two instances of a same “prototype formant” as soon as their distance DIST is smaller than a “distance threshold”.

For the comparison, a computer expert can thus select distance thresholds between formants. It may for example be started with setting rather large thresholds, then progressively narrowing the thresholds to obtain significant results.

3.2 Sound Signatures

After having detected prototype formants as indicated previously, the set of the prototype formants corresponding to a determined type of noise is searched for. One or several “sound signatures” formed of a set {P1, P2 . . . Pr} of prototype formants are thus obtained for each specific noise, value r being likely to vary from one signature to another.

4. Real-Time Detection of Sound Phenomena

After the training, the family of classes of sound phenomena to be detected has been set, and the corresponding sound signature base has been built by training.

This sound signature base comprising the prototype formants and their descriptors is memorized in each of the microcomputers associated with the units under surveillance. The method of comparison according to the present invention between the detected sound formants of a current recording and the prototype sound formants is then implemented for each analysis window. The user selects a distance threshold between the prototype formant and the observed formant. It can thus be determined whether a signature corresponding to a set of determined sound formants is present, partially or totally, in an analysis window. For each noise class, that is, for each signature, the method further provides calculating the presence coefficient of a sound phenomenon of a considered class in an analysis window. The presence coefficient or trust threshold ranges between 0 and 100% and depends on the chosen thresholds and on the number of formants surely identified in a signature. Various types of presence probability calculations may be conventionally envisaged.

5. Main Devices and Alternatives of the Present Invention

5.1 Embarked Elements

Aboard each monitored unit, the present invention provides the installation of identical embarked hardware, comprising:
microphones dedicated to the permanent or intermittent recording of the sound ambiances aboard the monitored unit; these microphones are connected, by wire or radio transmission, to an embarked microcomputer;
an embarked microcomputer, typically with no screen, for example of compact industrial PC type, comprising one or several audio acquisition cards, dedicated to the real-time digitization of the sound recordings transmitted by the microphones, and further comprising one or several computation circuit cards with fast processors, and possibly a large-capacity hard disk; and
a real-time audio telediagnosis software, installed on the embarked microcomputer, in charge of analyzing on line the flow of digitized sound recordings, to detect abnormal sound environments, identify them, and trigger the transmission of corresponding alarms.

At a regular rate, every second, for example, the audio telediagnosis software automatically analyzes the last received sound recordings, computes a diagnosis and, if a risk sound phenomenon is detected, automatically starts the transmission of an alarm message, specifying the detected alarm type with an identification of the corresponding risk event type (explosion, gun shot, screams, glass breaking, etc.).

5.2 Centralized Equipment

The present invention provides and alarm transmission system from each of the monitored units to one or several central surveillance stations, where the alarms triggered and identified by the embarked hardware are received on fixed computers or mobile receivers for display and reading by human operators, in charge of taking the necessary intervention decisions.

The alarm transmission system may be implemented in various ways, for example, by GSM transmission to an orbiting satellite, which then transmits back to the central surveillance stations for reception and display, by radio transmission on frequency bands reserved for the SDS, with a reception and display on mobile phones, portable computers, or fixed computers, or by any other system capable of ensuring such real-time alarm transmissions.

5.3 Doubt-Removing Functionalities

Optionally, the present invention provides a complementary functionality to help removing the doubt on each alarm transmission, to help the human operators assigned to the surveillance computers, in the task of direct alarm validation, which task consists of confirming or making the alarm diagnosis provided by the system more accurate.

For this purpose, the embarked telediagnosis software implements and permanently updates, by storage on a hard disk embarked aboard each unit under surveillance, the computer memorization of a last sequence of sound recordings coming from the microphones, of a duration chosen by the users of the audio surveillance system, on the order of from 15 to 30 seconds, for example. This storage may imply a software compression of the memorized sound data.

At each alarm transmitted by the audio surveillance system, the embarked telediagnosis software transmits back to the surveillance computers the last sound sequence recorded and memorized aboard the involved monitored unit. Such sound retransmissions for example use the satellite transmission GPRS protocol. Such sound retransmissions may also be implemented in various other ways, for example, by radio transmission on frequency bands reserved for the SDS, with a reception on a mobile phone, a portable computer, or a fixed computer.

As another option, the present invention provides enhancing the doubt removal function by installing aboard each unit under surveillance an embarked digital or analog video camera system, capable of permanently recording and storing on computerized memories the last recorded sequence.

As soon as an alarm is triggered by the audio telediagnosis software aboard a monitored unit, a standard computer program sub-samples at a sufficient rate (for example, 2 to 5 images/second) the last seconds of recorded video, than launches the computer compression of the stored images, then transmits them in real time to the surveillance computers, via GPRS-type satellite communication, for example, or yet via radio transmission.

Of course, the present invention is likely to have various alterations, modifications, and improvements which will readily occur to those skilled in the art. In particular, the type of sound to be detected and the type of locations or of transportation mode to be monitored may be extremely varied.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

1. A method of automated identification of specific sounds in a noise environment, comprising the steps of:
a) continuously recording the noise environment,
b) forming a spectral image of the sound recorded in a time/frequency coordinate system,
c) analyzing time-sliding windows of the spectral image,
d) selecting a family of filters, each of which defines a frequency band and an energy band,
e) applying each of the filters to each of the sliding windows, and identifying connected components or formants, which are window fragments formed of neighboring points of close frequencies and powers,
f) calculating descriptors of each formant, and
g) calculating a distance between two formants by comparing the descriptors of the first formant with those of the second formant.

2. A method of automated identification of the signature of a specific type of noise in a sound recording, comprising the steps of:
listening to the recording and marking the times at which a specific noise occurs,
applying the method of automated identification of specific sounds of claim 1 and, at step g), comparing the formants present in the windows substantially corresponding to the marked times, and
note down the formants common to all the windows corresponding to the marked times, these common formants altogether forming said signature, two formants being considered as identical if their distance is smaller than a set threshold.

3. A method of automated identification of specific sounds in a noise environment, consisting of applying the method of claim 1 and, at step g), of comparing the descriptors of the formants of each sliding window with formants belonging to a predetermined signature.

4. The method of claim 1, wherein the descriptors comprise a descriptor (D1) of geometric shape GeomC which is formed of the set of points of the formant to which a time translation has been applied to bring all the formants back to a same origin; and at least one of the following descriptors:
D2: relative surface area SurfC, that is, the ratio of the number of points of the formant to the number of points (L×k) of the analysis window;
D3: duration DuréeC, equal to v−u, where u and v respectively are the minimum and the maximum of abscissas t of the formant points;
D4: mean spectral energy MeanEnerC;
D5: the mean square deviation of spectral energies DispEnerC;
D6: frequency band BFreqC, which is the frequency interval, that is, the difference between the minimum and the maximum of the formant ordinates; and
D7: energy band BEnerC, which is the interval between the minimum and the maximum of the energies (Sₜⱼ) of the formant points.

5. The method of claim 4, wherein the distance between geometric shapes of two formants C and P is evaluated by calculated a raw numerical interval H(C,P):
H(C,P)=a/n(C)+b/n(P)
where n(C) and n(P) are the respective numbers of points of C and P, a is the number of points of C that do not belong to P, and b is the number of points of P that do not belong to C.

6. The method of claim 5, wherein the distance between the geometric shapes of two formants is evaluated by comparing the first formant with various instances of the second formant having undergone linear transformations (translation and expansion) of reduced amplitudes and by retaining the minimum distance.

7. A system of automated identification of specific sounds in a sound environment, comprising sound recording means and a microcomputer incorporating a software capable of implementing the method of any of claims 1 to 6.

8. A remote-surveillance system comprising the system of automated identification of specific sounds of claim 7, in each of a plurality of units under surveillance and means of alarm transmission to at least one central station.
